(19) United States
(12) Patent Application Publication
(10) Pub. No.: US 2025/0347228 A1
(43) Pub. Date: Nov. 13, 2025

(54) TURBINE AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Hiroshi NAKAGAWA, Sagamihara-shi (JP); Takashi YOSHIMOTO, Sagamihara-shi (JP); Kosuke UCHIUMI, Sagamihara-shi (JP); Koki NAKAJIMA, Sagamihara-shi (JP); Eigo KATO, Tokyo (JP); Noriyuki HAYASHI, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 18/869,646

(22) PCT Filed: Jul. 6, 2022
(86) PCT No.: PCT/JP2022/026836

§ 371 Date: Nov. 26, 2024

(51) Int. Cl. F01D 17/16

(52) U.S. Cl. CPC F01D 17/165; F05D 2220/40; F05D 2240/128; F05D 2300/611

(57) ABSTRACT

This turbine comprises: a first housing that has a scroll passage; a first platelike member that includes an annular first plate; a second platelike member that includes an annular second plate forming a gas passage between the first plate and the second plate; a second housing that has a facing surface facing the back surface, of the first plate, on a side opposite to the gas passage across a first space; an annular member that is disposed in the first space and that rotates with respect to the first platelike member; a link member coupled at one end to the annular member and coupled at the other end to a variable nozzle vane; a positioning pin fitted at one end in a first hole formed in the back surface of the first plate and fitted at the other end in a second hole formed in the facing surface of the second housing; and a stopper configured such that a first gap is formed between the facing surface, or the first plate, and the stopper, and the first gap is smaller than a second gap between the annular member and the facing surface, and than a third gap between the link member and the facing surface.

### TECHNICAL FIELD

The present disclosure relates to a turbine and a turbocharger.

### BACKGROUND ART

As a turbocharger (supercharger) that utilizes energy from exhaust gas of an internal combustion engine (engine) to supercharge intake of the internal combustion engine, a turbocharger including a variable capacity turbine is known (for example, see PTL 1). In the variable capacity turbine, a plurality of nozzle vanes are disposed in a circumferential direction of a turbine wheel in an exhaust gas flow path for sending the exhaust gas from a scroll flow path of the turbine to the turbine wheel, and a flow path cross-sectional area (flow path between adjacent nozzle vanes) of the exhaust gas flow path can be adjusted by changing a vane angle of the nozzle vanes from an outside by means of an actuator. The variable capacity turbine is a turbine that increases a supercharging effect by changing a flow velocity or a pressure of the exhaust gas guided to the turbine wheel by adjusting a flow path cross-sectional area of the exhaust gas flow path.

In PTL 1, two plate-like members (a nozzle mount and a nozzle plate) forming an exhaust gas flow path are connected to each other through a nozzle support, and a press-fitting pin (positioning pin) for positioning the nozzle mount and a bearing housing is press-fitted into a press-fitting hole formed in the nozzle mount.

### CITATION LIST

### Patent Literature

[PTL 1] Japanese Unexamined Patent Application Publication No. 2013-072401

### SUMMARY OF INVENTION

### Technical Problem

There is a concern that, due to thermal deformation during the operation of the variable capacity turbine, the nozzle mount approaches a bearing housing side, the press-fitting pin is excessively inserted into the press-fitting hole, frictional resistance between the press-fitting pin and the press-fitting hole increases, and the press-fitting pin is stuck in the press-fitting hole. In a case where the press-fitting pin is stuck in the press-fitting hole, there is a concern that a variable nozzle mechanism is lifted and is exposed to a risk of abrasion due to vibration and the like without being able to maintain a holding structure of the variable nozzle mechanism.

In view of the above circumstances, an object of at least one embodiment of the present disclosure is to provide a turbine and a turbocharger that can stably maintain a holding structure of a variable nozzle unit by suppressing sticking of a positioning pin.

### Solution to Problem

A turbine according to at least one embodiment of the present disclosure includes
a first housing that has a scroll flow path;
a turbine wheel that is provided on an inner peripheral side of the scroll flow path;
a first plate-like member that includes an annular first plate portion;
a second plate-like member that includes an annular second plate portion that is disposed to face the first plate portion and that forms a gas flow path from the scroll flow path toward the turbine wheel between the first plate portion and the second plate portion;
at least one variable nozzle vane that is disposed in the gas flow path;
a second housing that has a facing surface that faces a back surface of the first plate portion on a side opposite to a flow path wall surface facing the gas flow path with a first space interposed therebetween;
an annular member that is disposed in the first space and that is configured to rotate with respect to the first plate-like member by means of a driving force from an outside;
at least one link member with one end being connected to the annular member and the other end being connected to the variable nozzle vane, which changes a vane angle of the variable nozzle vane connected to the other end in conjunction with the rotation of the annular member;
a biasing member that is disposed between the second housing and the first plate-like member and that is configured to bias the first plate portion toward a side of the gas flow path;
at least one positioning pin of which one end is fitted into a first hole formed in the back surface of the first plate portion and the other end is fitted into a second hole formed in the facing surface of the second housing; and
at least one stopper portion that is provided in the facing surface or the first plate portion, in which a first gap is formed between the stopper portion and the facing surface or between the stopper portion and the first plate portion, and the first gap is smaller than a second gap between the annular member and the facing surface and a third gap between the at least one link member and the facing surface.

A turbocharger according to at least one embodiment of the present disclosure includes the turbine, and a centrifugal compressor configured to be driven by the turbine.

### Advantageous Effects of Invention

According to at least one embodiment of the present disclosure, a turbine and a turbocharger that can stably maintain a holding structure of a variable nozzle unit by suppressing sticking of a positioning pin are provided.

### BRIEF DESCRIPTION OF DRAWINGS

FIG. 1 is a schematic view of an internal combustion engine system including a turbocharger according to one embodiment.

FIG. 2 is a schematic cross-sectional view taken along an axis line of a turbine according to one embodiment.

FIG. 3 is a schematic view of a variable nozzle unit provided in the turbine according to one embodiment.

FIG. 4 is a schematic cross-sectional view illustrating a cross section taken along an axis line on one side with respect to the axis line of the turbine according to one embodiment.

FIG. 5 is a schematic cross-sectional view illustrating a cross section taken along the axis line on one side with respect to the axis line of the turbine according to one embodiment.

FIG. 6 is a schematic cross-sectional view illustrating a cross section taken along the axis line on one side with respect to the axis line of the turbine according to one embodiment.

FIG. 7 is a schematic cross-sectional view illustrating a cross section taken along the axis line on one side with respect to the axis line of the turbine according to one embodiment.

FIG. 8 is an explanatory diagram for describing a tongue portion vicinity side and a tongue portion distant side.

FIG. 9 is a schematic view of a variable nozzle unit provided in the turbine according to one embodiment.

FIG. 10 is a schematic cross-sectional view illustrating a cross section taken along the axis line on one side with respect to the axis line of the turbine according to one embodiment.

### DESCRIPTION OF EMBODIMENTS

Hereinafter, some embodiments of the present disclosure will be described with reference to the accompanying drawings. Dimensions, materials, shapes, relative arrangements, and the like of components described as embodiments or illustrated in the drawings are not intended to limit the scope of the present disclosure, but are merely explanatory examples.

### (Turbocharger)

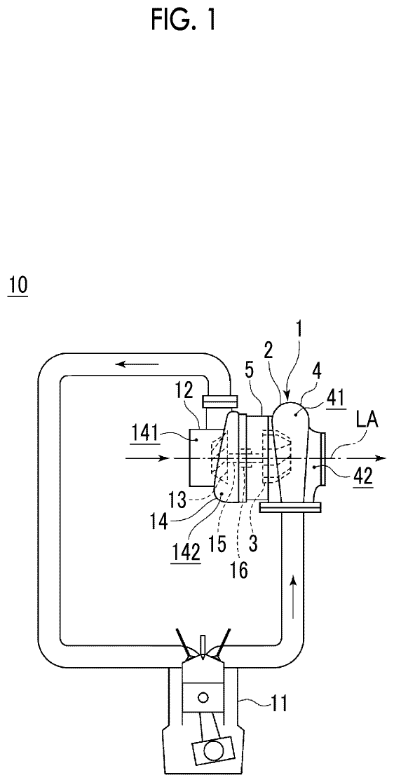

FIG. 1 is a schematic view of an internal combustion engine system 10 including a turbocharger 1 according to one embodiment. A turbine 2 according to the present disclosure can be mounted in, for example, a turbocharger (supercharger) 1 for an automobile, a ship, or an industrial application (for example, for land-based power generation). In each of the following embodiments, the turbine 2 mounted in the turbocharger 1 will be described as an example, but the turbine 2 according to the present disclosure is not limited to the turbine mounted in the turbocharger 1. In addition, an operating fluid of the turbine 2 does not need to be limited to an exhaust gas. That is, the turbine 2 of the present disclosure may be configured to convert operating fluid energy into mechanical power (for example, rotational force) and may be configured as a standalone turbine 2 or in combination with a mechanism or a device other than a centrifugal compressor 12. In addition, the use of the turbine 2 and the like does not need to be limited.

As illustrated in FIG. 1, the turbocharger 1 according to some embodiments is configured to be driven by energy of exhaust gas discharged from an internal combustion engine (engine) 11 and to compress a fluid (for example, air). The turbocharger 1 includes the turbine 2 and the centrifugal compressor 12 configured to be driven by the turbine 2.

The centrifugal compressor 12 includes an impeller 13 and a compressor housing 14 configured to rotatably accommodate the impeller 13. The turbine 2 includes at least a turbine wheel 3, a first housing (turbine housing) 4, and a second housing (bearing housing) 5 configured to rotatably accommodate the turbine wheel 3 between the first housing 4 and the second housing 5.

As illustrated in FIG. 1, the turbocharger 1 further includes a rotating shaft 15 to which the turbine wheel 3 is connected to one end side and to which the impeller 13 is connected to the other end side, and a bearing 16 that is configured to rotatably support the rotating shaft 15 between the turbine wheel 3 and the impeller 13. The second housing 5 is disposed between the first housing 4 and the compressor housing 14, and is connected to each of the first housing 4 and the compressor housing 14, for example, via a fastening member (not illustrated) such as a bolt or a nut. The second housing 5 may be configured to accommodate the bearing 16.

The turbine 2 of the turbocharger 1 is configured to rotate the turbine wheel 3 by means of energy of the exhaust gas discharged from the internal combustion engine 11. The impeller 13 is connected to the turbine wheel 3 on the same axis via the rotating shaft 15, and thus the impeller 13 is rotationally driven around an axis line LA in conjunction with the rotation of the turbine wheel 3. The centrifugal compressor 12 of the turbocharger 1 is configured to rotationally drive the impeller 13 around the axis line LA to intake air (air supply, gas) into the compressor housing 14, compress the air, and send the compressed air to the internal combustion engine 11.

The compressed air sent from the centrifugal compressor 12 to the internal combustion engine 11 is supplied for combustion in the internal combustion engine 11. The exhaust gas generated by the combustion in the internal combustion engine 11 is sent from the internal combustion engine 11 to the turbine 2 to rotate the turbine wheel 3.

### (Impeller)

As illustrated in FIG. 1, the impeller 13 is connected to the other end side of the rotating shaft 15, and thus is rotatably provided integrally with the rotating shaft 15 about an axis line of the impeller 13 as a center. The impeller 13 is configured to guide the air introduced along an axial direction of the impeller 13 to the outside of the impeller 13 in a radial direction. In the illustrated embodiment, the impeller 13 consists of an open type impeller that does not include an annular member surrounding an outer periphery of blades of the impeller 13.

### (Compressor Housing)

Inside the compressor housing 14, a gas introduction flow path 141 and a scroll flow path 142 are formed. In other words, the compressor housing 14 includes a gas introduction flow path 141 and a scroll flow path 142.

The gas introduction flow path 141 is a flow path for taking in air (gas) from the outside of the compressor housing 14 (centrifugal compressor 12) and guiding the taken-in air to the impeller 13. The gas introduction flow path 141 is provided on one side of the impeller 13 in the axial direction with respect to the impeller 13 and extends along the axial direction of the impeller 13. By rotationally driving the impeller 13, air is taken into the gas introduction flow path 141 from the outside of the compressor housing 14, and the taken-in air flows in the gas introduction flow path 141 toward the impeller 13 and is guided to the impeller 13.

The scroll flow path 142 is provided on an outer peripheral side of the impeller 13 and consists of a spiral flow path extending along a circumferential direction of the impeller 13. The air that passes through the impeller 13 and that is compressed by the impeller 13 is guided to the scroll flow path 142. The compressed air passing through the scroll flow path 142 is guided to the internal combustion engine 11.

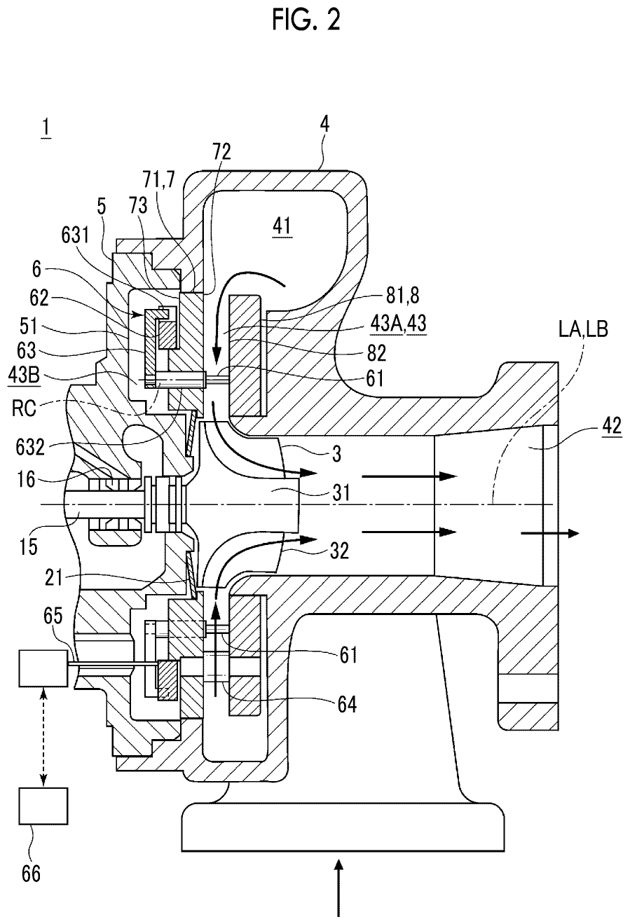

FIG. 2 is a schematic cross-sectional view taken along the axis line LA of the turbine 2 according to one embodiment. Hereinafter, a direction in which the axis line LA of the turbine wheel 3 extends is defined as an axial direction of the turbine wheel 3, a direction orthogonal to the axis line LA is defined as a radial direction of the turbine wheel 3, and a circumferential direction around the axis line LA is defined as a circumferential direction of the turbine wheel 3. Hereinafter, a side (right side in FIG. 2) on which the first housing 4 is positioned with respect to the second housing 5 in the axial direction of the turbine wheel 3 is defined as a front side, and a side (opposite to the front side, left side in FIG. 2) on which the second housing 5 is positioned with respect to the first housing 4 is defined as a rear side.

### (Turbine Wheel)

As illustrated in FIG. 2, the turbine wheel 3 includes a hub 31 having a substantially frustoconical shape and a plurality of turbine blades 32 provided on an outer peripheral surface of the hub 31. Each of the plurality of turbine blades 32 is disposed at intervals in the circumferential direction around the axis line LA. The hub 31 and the plurality of turbine blades 32 are provided to be rotatable integrally with the rotating shaft 15 about the axis line LA as the center. The turbine wheel 3 is configured to guide the exhaust gas introduced from the outside of the turbine wheel 3 in the radial direction to the front side of the turbine wheel 3 along the axial direction of the turbine wheel 3.

### (Scroll Flow Path and Exhaust Gas Discharge Flow Path)

Inside the first housing 4, a scroll flow path 41 for guiding the exhaust gas discharged from the internal combustion engine 11 to the turbine wheel 3 and an exhaust gas discharge flow path 42 for discharging the exhaust gas passing through the turbine wheel 3 to the outside of the first housing 4 (turbine 2) are formed. In other words, the first housing 4 includes the scroll flow path 41 and the exhaust gas discharge flow path 42. The scroll flow path 41 is provided on an outer peripheral side of the turbine wheel 3 and consists of a spiral flow path extending along the circumferential direction of the turbine wheel 3. The exhaust gas discharge flow path 42 extends from the turbine wheel 3 toward the front side along the axial direction of the turbine wheel 3.

The first housing 4 and the second housing 5 are fastened to each other, so that an internal space 43 connecting the scroll flow path 41 and the exhaust gas discharge flow path 42 is formed between the first housing 4 and the second housing 5. The turbine wheel 3 is rotatably accommodated in the internal space 43 with respect to the first housing 4 and the second housing 5. The turbine wheel 3 is provided on an inner peripheral side of the scroll flow path 41.

The exhaust gas discharged from the internal combustion engine 11 is guided to the turbine wheel 3 through the scroll flow path 41, and the turbine wheel 3 is rotationally driven. The exhaust gas that causes the turbine wheel 3 to be rotationally driven is discharged to the outside of the first housing 4 (turbine 2) through the exhaust gas discharge flow path 42.

### (Variable Nozzle Unit)

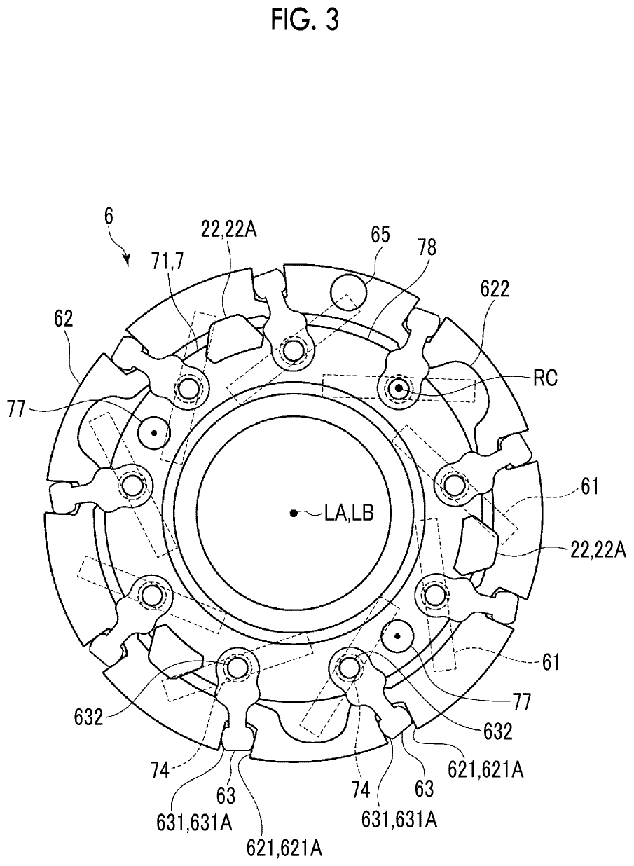

FIG. 3 is a schematic view of a variable nozzle unit 6 provided in the turbine 2 according to one embodiment. As illustrated in FIG. 2, the turbine 2 further includes the variable nozzle unit 6 that is accommodated on the outer peripheral side of the turbine wheel 3 in the above-mentioned internal space 43. The variable nozzle unit 6 forms a gas flow path (exhaust gas flow path) 43A for guiding the exhaust gas from the scroll flow path 41 to the turbine wheel 3 and adjusts the flow of the exhaust gas in the gas flow path 43A. The gas flow path 43A is a part of the internal space 43. The gas flow path 43A is formed between the scroll flow path 41 and the turbine wheel 3 so as to surround a periphery of the turbine wheel 3 (the outer side in the radial direction).

As illustrated in FIG. 2, the variable nozzle unit 6 includes a first plate-like member (nozzle mount) 7, a second plate-like member (nozzle plate) 8, at least one (a plurality in the illustrated example) variable nozzle vane 61, an annular member (drive ring) 62, and at least one (a plurality in the illustrated example) link member (lever plate) 63.

### (First Plate-Like Member)

The first plate-like member (nozzle mount) 7 includes an annular first plate portion 71 that extends along the circumferential direction of the turbine wheel 3 on the outer peripheral side of the turbine wheel 3. A first flow path wall surface 72 facing the gas flow path 43A is formed on a front side of the first plate portion 71, and a back surface 73 is formed on a rear side of the first plate portion 71, that is, on a side opposite to the first flow path wall surface 72.

### (Second Plate-Like Member)

The second plate-like member (nozzle plate) 8 includes an annular second plate portion 81 that is disposed to face the first plate portion 71 and forms a gas flow path 43A from the scroll flow path 41 toward the turbine wheel 3 between the first plate portion and the second plate portion 81. The second plate portion 81 is disposed on the front side of the first plate portion 71 and extends along the circumferential direction of the turbine wheel 3 on the outer peripheral side of the turbine wheel 3. A second flow path wall surface 82 facing the gas flow path 43A is formed on a rear side of the second plate portion 81.

The gas flow path 43A is formed between the first flow path wall surface 72 and the second flow path wall surface 82. The first flow path wall surface 72 is positioned on a rear side of the second flow path wall surface 82 and faces the second flow path wall surface 82. The exhaust gas introduced into the turbine 2 is guided to the turbine wheel 3 through the scroll flow path 41 and then through the gas flow path 43A, and rotates the turbine wheel 3.

### (Support Member)

As illustrated in FIG. 2, the variable nozzle unit 6 may further include at least one (for example, a plurality of) support member (nozzle support) 64 that supports the first plate-like member 7 and the second plate-like member 8 in a state of being separated from each other. Each of the plurality of support members 64 are disposed at intervals in the circumferential direction of the turbine wheel 3. One side of each of the plurality of support members 64 is fixed to the first plate portion 71, and the other side thereof is fixed to the second plate portion 81. The second plate-like member 8 is supported by the support member 64 to be separated from the first plate-like member 7 on the front side.

### (First Space)

The second housing 5 has a facing surface 51 that faces the back surface 73 of the first plate portion 71 with a first space 43B interposed therebetween. The first space 43B is a part of the internal space 43 and is formed on a side opposite to the gas flow path 43A with the first plate portion 71 interposed therebetween.

### (Variable Nozzle Vane)

Each of the plurality of variable nozzle vanes 61 is disposed in the gas flow path 43A and is rotatably supported around a rotation center RC of each of the first plate portions 71 (first plate-like members 7). The plurality of variable nozzle vanes 61 are disposed at intervals in the circumferential direction of the turbine wheel 3.

### (Annular Member)

The annular member (drive ring) 62 is disposed in the first space 43B and is configured to be rotated around an axis line LB of the annular member 62 (variable nozzle unit 6) with respect to the first plate-like member 7 by a driving force from the outside.

### (Driving Mechanism Unit and Control Device)

As illustrated in FIG. 2, the turbine 2 further includes a driving mechanism unit (actuator) 65 configured to transmit a driving force to the annular member 62 and to rotate the annular member 62 around the axis line LB, and a control device (controller) 66 configured to control the rotation of the annular member 62 around the axis line LB. The driving mechanism unit 65 includes an electric motor that generates a driving force, an air cylinder that transmits the driving force, and the like.

### (Link Member)

As illustrated in FIG. 3, the variable nozzle unit 6 includes link members (lever plates) 63 which are the same in number as the variable nozzle vanes 61. Each of the plurality of link members 63 is disposed in the first space 43B, has one end 631 connected to the annular member 62, has the other end 632 connected to the variable nozzle vane 61, and is configured to change a vane angle of the variable nozzle vane 61 connected to the other end 632 in conjunction with the rotation of the annular member 62.

In the embodiment illustrated in FIG. 3, one end 631 of each link member 63 includes a fitting portion 631A that is fitted into a fitting target portion 621 formed in the annular member 62. The fitting target portion 621 includes a groove portion 621A formed in an outer peripheral edge portion of the annular member 62, and the fitting portion 631A is accommodated in the groove portion 621A and is loosely fitted into the groove portion 621A. The first plate portion 71 has a plurality of through-holes 74 that penetrate the first flow path wall surface 72 and the back surface 73. Each of the plurality of through-holes 74 is disposed at intervals in the circumferential direction of the turbine wheel 3. The first plate portion 71 is formed with the same number of through-holes 74 as the variable nozzle vane 61 and the link member 63. The other end of each link member 63 is inserted into a through-hole 74 individually corresponding to the link member 63 and is connected to the variable nozzle vane 61 individually corresponding to the link member 63.

In a case where the annular member 62 is rotated to one side in the circumferential direction of the turbine wheel 3, the variable nozzle vanes 61 adjacent to each other in the circumferential direction are moved (rotated) in a direction of being separated from each other, and a flow path cross-sectional area of the gas flow path 43A between the variable nozzle vanes 61 is increased. In addition, in a case in which the annular member 62 is rotated to the other side in the circumferential direction of the turbine wheel 3, the variable nozzle vanes 61 adjacent to each other in the circumferential direction are moved (rotated) in a direction of approaching each other, and the flow path cross-sectional area of the gas flow path 43A between the variable nozzle vanes 61 is reduced.

The variable nozzle unit 6 can adjust the flow path cross-sectional area of the gas flow path 43A by transmitting a driving force from the outside (driving mechanism unit 65) of the variable nozzle unit 6 to the plurality of variable nozzle vanes 61 via the annular member 62 and the plurality of link members 63 to rotate the plurality of variable nozzle vanes 61 around the rotation center RC of each of the variable nozzle vanes 61 and change the vane angle of each of the variable nozzle vanes 61. The turbine 2 can change a flow velocity and a pressure of the exhaust gas guided to the turbine wheel 3 by increasing or decreasing the flow path cross-sectional area of the gas flow path 43A by means of the variable nozzle unit 6, and thus boost pressure of the turbine 2 can be controlled.

### (Biasing Member)

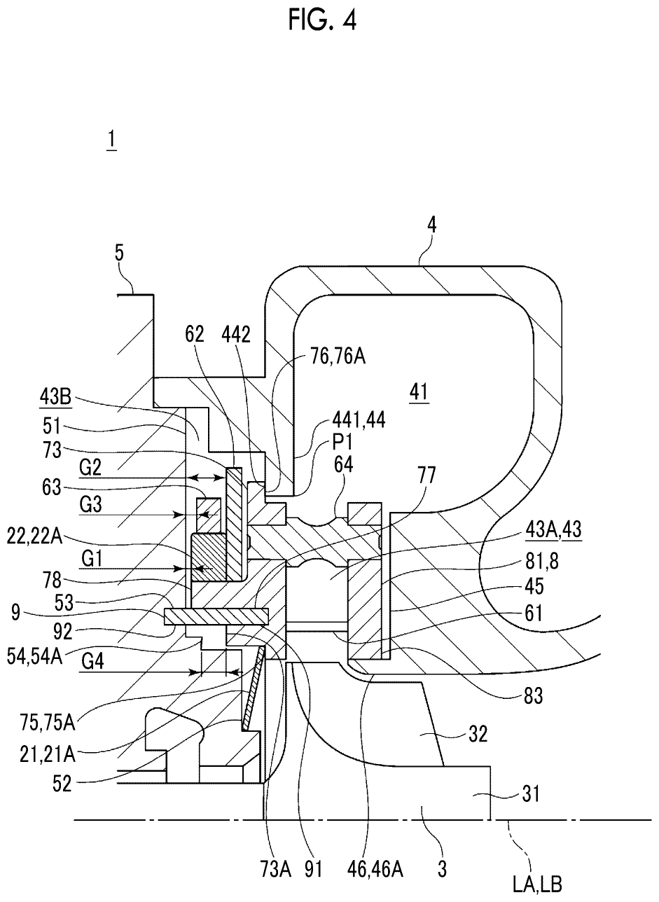

FIG. 4 is a schematic cross-sectional view illustrating a cross section taken along the axis line LA on one side with respect to the axis line LA of the turbine 2 according to one embodiment. As illustrated in FIG. 4, the turbine 2 further includes a biasing member 21 that is disposed between the second housing 5 and the first plate-like member 7 and that is configured to bias the first plate portion 71 toward a side of the gas flow path 43A.

In the embodiment illustrated in FIG. 4, the biasing member 21 includes a dish spring 21A that abuts against an end surface 52 formed on an inner side of the facing surface 51 of the second housing 5 in the radial direction and an end surface 75A on a side opposite to the first flow path wall surface 72 of an inner peripheral edge portion 75 of the first plate portion 71. The end surface 75A is formed on an inner side of the back surface 73 in the radial direction. A space between the end surface 52 of the second housing 5 and the end surface 75A of the first plate portion 71 is sealed by the dish spring 21A (biasing member 21), and thus the inflow of the exhaust gas into the first space 43B from a back surface side of the turbine wheel 3 is suppressed.

The first housing 4 includes a locked portion 44 that extends along the radial direction of the turbine wheel 3 and to which an outer peripheral edge portion 76 of the first plate portion 71 is locked. The locked portion 44 has a rear side scroll flow path wall surface 441 that extends from a rear end P1 of the scroll flow path 41 to the outside in the radial direction, and a locked surface 442 that is positioned on a side opposite to the rear side scroll flow path wall surface 441 in the axial direction and that faces the first space 43B.

The first plate-like member 7 is biased forward by the biasing member 21, so that the outer peripheral edge portion 76 of the first plate portion 71 is pressed against the locked portion 44 of the first housing 4, and a locking surface 76A on a front side of the outer peripheral edge portion 76 abuts against the locked surface 442. Accordingly, a space between the locking surface 76A and the locked surface 442 on the front side is sealed, and thus the inflow of the exhaust gas from the scroll flow path 41 to the first space 43B is suppressed. In the illustrated embodiment, the locking surface 76A consists of a step surface formed on the outside and the rear side of the first flow path wall surface 72 in the radial direction. In addition, in several other embodiments, the outer peripheral edge portion 76 of the first plate portion 71 may be sandwiched between the first housing 4 and the second housing 5.

In the embodiment illustrated in FIG. 4, the first housing 4 includes a front side facing surface 45 that faces a second back surface 83 of the second plate portion 81, and a shroud portion 46 that protrudes rearward of the front side facing surface 45 on an inner side of the second plate portion 81 and the front side facing surface 45 in the radial direction. The shroud portion 46 has a shroud surface 46A that is curved in a convex shape so as to face a tip-side end (tip) of the plurality of turbine blades 32 and has a gap (clearance) between the tip-side end and the shroud surface 46A.

### First Embodiment

As illustrated in FIG. 4, the turbine 2 according to some embodiments includes at least the above-mentioned turbine wheel 3, the first housing 4, the second housing 5, the first plate-like member 7, the second plate-like member 8, the biasing member 21, at least one variable nozzle vane 61, the annular member 62, and at least one link member 63. As illustrated in FIG. 4, the turbine 2 further includes at least one positioning pin 9 and at least one stopper portion 22. It should be noted that the present embodiment can be implemented independently of other embodiments.

### (Positioning Pin)

As illustrated in FIG. 4, at least one positioning pin 9 has one end 91 thereof fitted (for example, press-fitted) into a first hole 77 formed in the back surface 73 of the first plate portion 71, and the other end 92 thereof fitted (for example, press-fitted) into a second hole 53 formed in the facing surface 51 of the second housing 5. The positioning pin 9 is formed in a rod shape having a longitudinal direction along the axial direction of the turbine 2. The positioning pin 9 is formed of, for example, a metallic material. In order to improve the assemblability of the turbine 2, the variable nozzle unit 6 is connected to the second housing 5 via the positioning pin 9, whereby the variable nozzle unit 6 is prevented from falling off from the second housing 5.

### (Stopper Portion)

At least one stopper portion 22 is provided on the facing surface 51 or the first plate portion 71. As illustrated in FIG. 4, at least one stopper portion 22 may be integrally configured with the first plate portion 71 or may be integrally configured with the facing surface 51. In addition, at least one stopper portion 22 is a member different from the facing surface 51 or the first plate portion 71, and may be attached to the facing surface 51 or the first plate portion 71.

As illustrated in FIG. 4, the turbine 2 has a first gap G1 formed between the stopper portion 22 and the facing surface 51 (illustrated example) or between the stopper portion 22 and the first plate portion 71. The first gap G1 is configured to be smaller than a second gap G2 between the annular member 62 and the facing surface 51 and a third gap G3 between the facing surface 51 and at least one link member 63.

According to the above configuration, the first plate-like member 7 approaches a side of the second housing 5 due to thermal deformation during the operation of the turbine 2, but the movement of the first plate-like member 7 to the side of the second housing 5 can be restricted by bringing the stopper portion 22 into abutment with the facing surface 51 of the second housing 5 or the first plate portion 71. By restricting the movement of the first plate-like member 7 to the side of the second housing 5, it is possible to prevent the positioning pin 9 from being excessively inserted into the first hole 77 or the second hole 53 and being stuck in the first hole 77 or the second hole 53.

Here, in a case where the turbine 2 does not include the stopper portion 22, there is a concern that the first plate-like member 7 approaches the side of the second housing 5 by more than the first gap G1 during the operation of the turbine 2 due to the thermal deformation. In this case, there is a concern that, since the positioning pin 9 is excessively inserted into the first hole 77 or the second hole 53 and frictional resistance between the first hole 77 or the second hole 53 and the positioning pin 9 is increased, it is not possible to maintain a holding structure of the variable nozzle unit 6 by means of a reaction force (a force for pushing back the first plate-like member 7 to a side of the gas flow path 43A) of the biasing member 21, and a gap may be generated between an outer peripheral edge portion 76 of the first plate-like member 7 and the locked portion 44 of the first housing 4, and the variable nozzle unit 6 may be lifted in the first space 43B. In this case, there is a concern that the variable nozzle unit 6 may be exposed to a risk of abrasion or the like due to vibration.

According to the above configuration, the movement of the first plate-like member 7 to the side of the second housing 5 is restricted by the stopper portions 22 described above, and thus it is possible to prevent the positioning pin 9 from being stuck in the first hole 77 or the second hole 53 and inhibiting the reaction force of the biasing member 21. In this case, the holding structure of the variable nozzle unit 6 (first plate-like member 7) can be stably maintained by the reaction force of the biasing member 21. By stably maintaining the holding structure of the variable nozzle unit 6, a risk of abrasion or the like due to vibration of the variable nozzle unit 6 can be reduced.

In some embodiments, the at least one stopper portion 22 described above is integrally configured with the first plate-like member 7. In this case, as compared with a case in which the stopper portion 22 is a member different from the first plate-like member 7 or the second housing 5, it is possible to suppress an increase in the number of components and to suppress an increase in the complexity of the structure of the turbine 2. In addition, in a case where the stopper portion 22 is integrally configured with the second housing 5, there is a concern that the stopper portion 22 interferes with the variable nozzle unit 6 when the variable nozzle unit 6 is mounted on the second housing 5. However, in a case where the stopper portion 22 is integrally configured with the first plate-like member 7, there is a relatively small concern that the stopper portion 22 interferes with the variable nozzle unit 6. In addition, forming the stopper portion 22 on the first plate-like member 7 is easier than forming the stopper portion 22 on the second housing 5.

In some embodiments, as illustrated in FIGS. 3 and 4, the first plate-like member 7 described above includes a tubular portion 78 that protrudes from the back surface 73 of the first plate portion 71 and that is inserted into a central hole of the annular member 62, and at least one claw portion 22A that protrudes from the tubular portion 78 to the outer peripheral side of the inner peripheral edge of the annular member 62 with the inner peripheral edge of the annular member 62 interposed between the back surface 73 of the first plate portion 71 and the claw portion 22A. The at least one stopper portion 22 described above includes at least one claw portion 22A. That is, the claw portion 22A of the first plate-like member 7 is used as the stopper portion 22.

In the embodiment illustrated in FIG. 3, the at least one claw portion 22A includes a plurality (three in the illustrated example) of claw portions 22A that are disposed at intervals along the circumferential direction of the turbine wheel 3. In the inner peripheral edge of the annular member 62, recessed portions 622 are formed in the same number as the number of the claw portions 22A in order to allow the claw portions 22A to pass through in a case where the first plate-like member 7 and the annular member 62 are assembled.

According to the above configuration, by using at least one claw portion 22A interposing the inner peripheral edge of the annular member 62 as the stopper portion 22, it is not necessary to newly provide a stopper portion protrusion on the first plate-like member 7. Therefore, it is possible to reduce the number of changes to the existing shape of the first plate-like member 7 and to reduce the complexity of the structure of the first plate-like member 7.

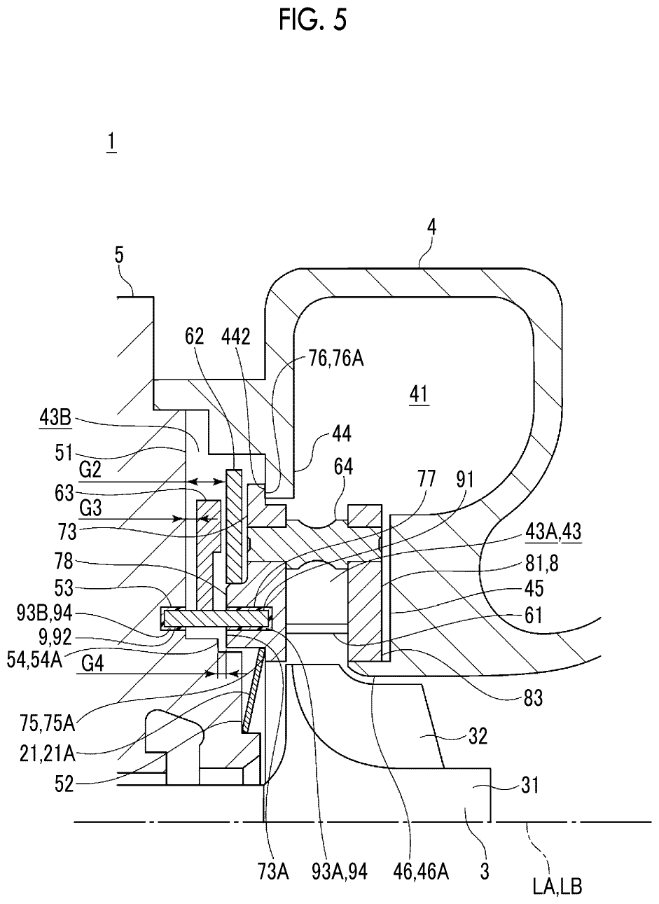

In the embodiment illustrated in FIGS. 4 and 5, the second housing 5 described above has a protrusion portion 54 that protrudes forward from the facing surface 51 along the axial direction of the turbine wheel 3. The protrusion portion 54 may be formed in an arc shape or a ring shape extending along the circumferential direction of the turbine wheel 3. In the turbine 2, a fourth gap G4 is formed between an end surface 54A of the protrusion portion 54 on the front side in the axial direction and the back surface 73 of the first plate portion 71. In the embodiments illustrated in FIGS. 4 and 5, the protrusion portion 54 (end surface 54A) is a part of the facing surface 51, is formed on the inner side in the radial direction from an outer peripheral edge portion of the facing surface 51 on which the protrusion portion 54 is not formed, and is formed on the outer side in the radial direction from the above-described end surface 52. The back surface 73 of the first plate portion 71 includes an inner peripheral side back surface 73A that is formed on an inner peripheral edge portion thereof and that forms the fourth gap G4 between the end surface 54A and the back surface 73 of the first plate portion 71.

In the embodiment illustrated in FIG. 4, the above-described fourth gap G4 is configured to be larger than the above-described second gap G2 and the above-described third gap G3.

In some embodiments, as illustrated in FIG. 5, the above-described fourth gap G4 is configured to be smaller than the above-described second gap G2 and the above-described third gap G3. In this case, the protrusion portion 54 can be used as the stopper portion 22. That is, in the embodiment illustrated in FIG. 5, the at least one stopper portion 22 described above is a protrusion portion 54 that is integrally configured with the second housing 5. The fourth gap G4 is the first gap G1 described above.

According to the above configuration, by using the protrusion portion 54 as the stopper portion 22, it is not necessary to newly provide a stopper portion protrusion on the second housing 5. Therefore, it is possible to reduce the number of changes to the existing shape of the second housing 5 and to reduce the complexity of the structure of the second housing 5.

### Second Embodiment

FIG. 5 is a schematic cross-sectional view illustrating a cross section taken along the axis line LA on one side with respect to the axis line LA of the turbine 2 according to one embodiment. As illustrated in FIG. 5, the turbine 2 according to some embodiments includes at least the above-mentioned turbine wheel 3, the first housing 4, the second housing 5, the first plate-like member 7, the second plate-like member 8, the biasing member 21, and at least one variable nozzle vane 61. As illustrated in FIG. 5, the turbine 2 further includes at least one positioning pin 9 and an adhesive layer 94. It should be noted that the present embodiment can be implemented independently of other embodiments. The turbine 2 may not include, for example, the stopper portion 22 described above.

### (Positioning Pin)

As illustrated in FIG. 5, at least one positioning pin 9 has one end 91 thereof inserted into a first hole 77 formed in the back surface 73 of the first plate portion 71, and the other end 92 thereof inserted into a second hole 53 formed in the facing surface 51 of the second housing 5. At least one of the one end 91 or the other end 92 of the positioning pin 9 is inserted in a state of having gaps 93A and 93B. The positioning pin 9 is formed in a rod shape having a longitudinal direction along the axial direction of the turbine 2. The positioning pin 9 is formed of, for example, a metallic material. In the illustrated embodiment, one end 91 of the positioning pin 9 is loosely inserted into the first hole 77, and a gap 93A is formed between an outer peripheral surface of the one end 91 and an inner peripheral surface of the first hole 77. In addition, the other end 92 of the positioning pin 9 is loosely inserted into the second hole 53, and a gap 93B is formed between the outer peripheral surface of the other end 92 and the inner peripheral surface of the second hole 53.

### (Adhesive Layer)

The adhesive layer 94 is interposed in at least one of the gap 93A or the gap 93B. In the illustrated embodiment, the adhesive layer 94 is interposed in both the gap 93A and the gap 93B. The adhesive layer 94 is configured to have reduced adhesive strength due to heat input during the operation of the turbine 2. Since the gap 93A is more affected by the heat input during the operation of the turbine 2 than the gap 93B, in a case where the adhesive layer 94 is interposed in any one of the gap 93A or the gap 93B, it is preferable to interpose the adhesive layer 94 in the gap 93A. The decrease in the adhesive strength of the adhesive layer 94 may be temporary or permanent during the operation of the turbine 2. In a case where the variable nozzle unit 6 is connected to the second housing 5 via the positioning pin 9 and the adhesive layer 94, the adhesive strength of the adhesive layer 94 is not reduced. Therefore, the variable nozzle unit 6 is prevented from falling off from the second housing 5.

According to the above configuration, since the adhesive strength of the adhesive layer 94 is reduced due to the heat input during the operation of the turbine 2, a gap is generated between at least one of the first hole 77 or the second hole 53 and the positioning pin 9. Therefore, it is possible to prevent the positioning pin 9 from being stuck in the first hole 77 or the second hole 53 in a case where the first plate-like member 7 approaches the side of the second housing 5 due to the thermal deformation during the operation of the turbine 2. By preventing the positioning pins 9 from being stuck in the first holes 77 or the second holes 53 and inhibiting the reaction force of the biasing member 21, the holding structure of the variable nozzle unit 6 (first plate-like member 7) can be stably maintained by the reaction force of the biasing member 21. By stably maintaining the holding structure of the variable nozzle unit 6, a risk of abrasion or the like due to vibration of the variable nozzle unit 6 can be reduced.

In some embodiments, the above-described adhesive layer 94 is formed of a thermoplastic resin material. The thermoplastic resin material may contain, for example, at least one of a phenoxy resin, a polyurethane resin, a polyester urethane resin, a butyral resin, an acrylic resin, a polyimide resin, or a polyamide resin.

According to the above configuration, the adhesive strength of the adhesive layer 94 is reduced by softening (for example, liquefying) the adhesive layer 94 formed of the thermoplastic resin material due to the heat input during the operation of the turbine 2, and thus the gaps 93A and 93B can be effectively generated between at least one of the first hole 77 or the second hole 53 and the positioning pin 9.

### Third Embodiment

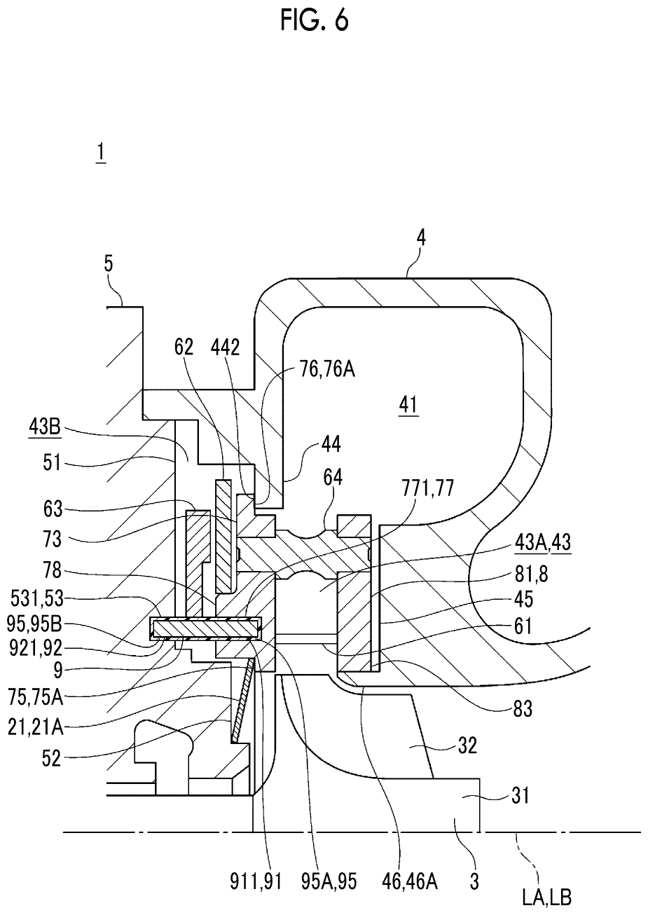

FIG. 6 is a schematic cross-sectional view illustrating a cross section taken along the axis line LA on one side with respect to the axis line LA of the turbine 2 according to one embodiment. As illustrated in FIG. 6, the turbine 2 according to some embodiments includes at least the above-mentioned turbine wheel 3, the first housing 4, the second housing 5, the first plate-like member 7, the second plate-like member 8, the biasing member 21, and at least one variable nozzle vane 61. As illustrated in FIG. 6, the turbine 2 further includes at least one positioning pin 9 and a sliding layer 95. It should be noted that the present embodiment can be implemented independently of other embodiments. The turbine 2 may not include, for example, the stopper portion 22 described above.

### (Positioning Pin)

As illustrated in FIG. 6, at least one positioning pin 9 has one end 91 thereof inserted into a first hole 77 formed in the back surface 73 of the first plate portion 71, and the other end 92 thereof inserted into a second hole 53 formed in the facing surface 51 of the second housing 5. The positioning pin 9 is formed in a rod shape having a longitudinal direction along the axial direction of the turbine 2. The positioning pin 9 is formed of, for example, a metallic material.

### (Sliding Layer)

The sliding layer 95 contains a solid lubricant that covers at least one of an outer peripheral surface 911 of the one end 91 of the at least one positioning pin 9, an outer peripheral surface 921 of the other end 92 of the at least one positioning pin 9, an inner peripheral surface 771 of the first hole 77, or an inner peripheral surface 531 of the second hole 53. The sliding layer 95 may be formed by applying or coating the solid lubricant on a target object such as the outer peripheral surfaces 911 and 921 of the positioning pin 9, the inner peripheral surface 771 of the first hole 77, or the inner peripheral surface 531 of the second hole 53. The solid lubricant may contain at least one of molybdenum disulfide, graphite, or polytetrafluoroethylene (PTFE).

In the illustrated embodiment, the sliding layer 95 includes a first hole side sliding layer 95A that covers at least one of the outer peripheral surface 911 of the one end 91 of the positioning pin 9 or the inner peripheral surface 771 of the first hole 77, and a second hole side sliding layer 95B that covers at least one of the outer peripheral surface 921 of the other end 92 of the positioning pin 9 or the inner peripheral surface 531 of the second hole 53. The sliding layer 95 may be provided over the entire length of the positioning pin 9. The first hole side sliding layer 95A reduces the frictional resistance between the outer peripheral surface 911 of the one end 91 of the positioning pin 9 and the inner peripheral surface 771 of the first hole 77. The frictional resistance between the outer peripheral surface 921 of the other end 92 of the positioning pin 9 and the inner peripheral surface 531 of the second hole 53 is reduced by the second hole side sliding layer 95B.

According to the above configuration, since the sliding layer 95 reduces the frictional resistance between at least one of the first hole 77 or the second hole 53 and the positioning pin 9, it is possible to prevent the positioning pin 9 from being stuck in the first hole 77 or the second hole 53 in a case where the first plate-like member 7 approaches the side of the second housing 5 due to the thermal deformation during the operation of the turbine 2. By preventing the positioning pins 9 from being stuck in the first holes 77 or the second holes 53 and inhibiting the reaction force of the biasing member 21, the holding structure of the variable nozzle unit 6 and the first plate-like member 7 can be stably maintained by the reaction force of the biasing member 21. By stably maintaining the holding structure of the variable nozzle unit 6, a risk of abrasion or the like due to vibration of the variable nozzle unit 6 can be reduced.

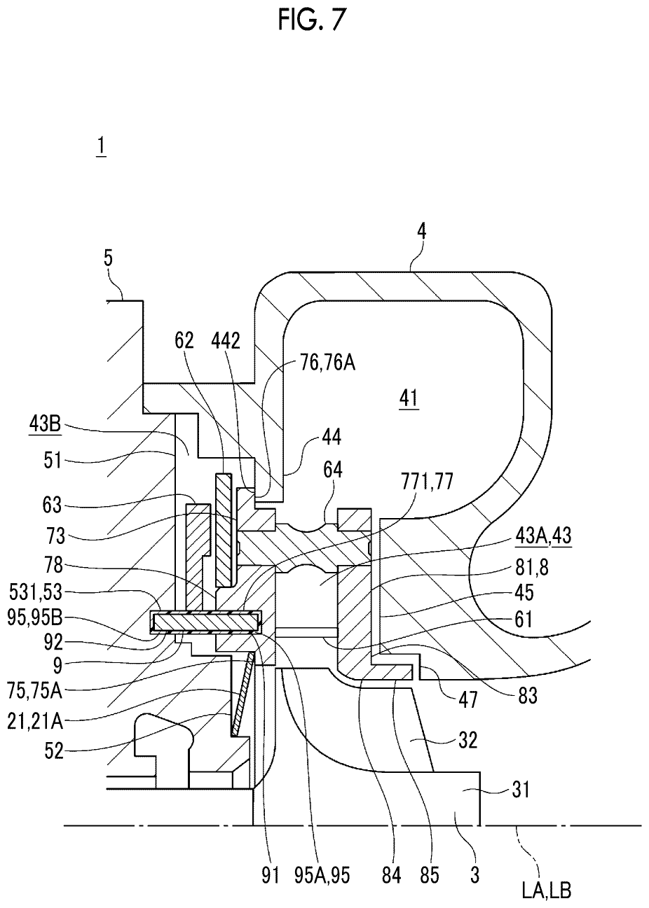

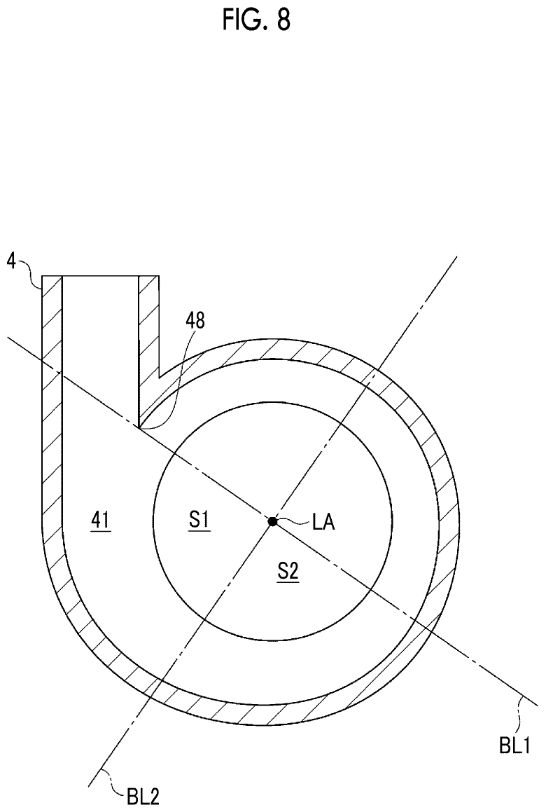

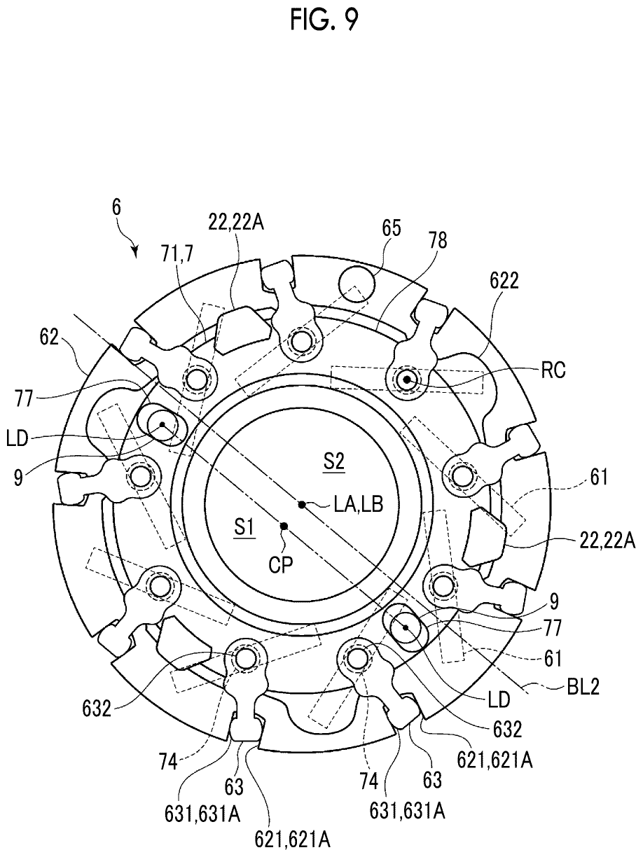

FIG. 7 is a schematic cross-sectional view illustrating a cross section taken along the axis line LA on one side with respect to the axis line LA of the turbine 2 according to one embodiment. FIG. 8 is an explanatory diagram for describing a tongue portion vicinity side S1 and a tongue portion distant side S2. FIG. 9 is a schematic view of a variable nozzle unit 6 provided in the turbine 2 according to one embodiment. In some embodiments, as illustrated in FIG. 9, at least one of the first hole 77 or the second hole 53 described above has a longitudinal direction along the radial direction of the turbine wheel 3.

The first plate portion 71 in which the first hole 77 is formed and the second housing 5 in which the second hole 53 is formed have a difference in thermal expansion amount during the operation of the turbine 2, and a shear force due to the difference in thermal expansion amount between the first plate portion 71 and the second housing 5 acts on the positioning pin 9.

According to the above configuration, by setting a hole shape of the first hole 77 or the second hole 53 to have a longitudinal direction along the radial direction of the turbine wheel 3, the positioning pin 9 does not restrain thermal expansion between the first plate portion 71 and the second housing 5 as compared with a case where the first hole 77 or the second hole 53 is a round hole (see FIG. 3). Therefore, it is possible to suppress the occurrence of an excessive load between the positioning pin 9 and the first hole 77 or between the positioning pin 9 and the second hole 53, and thus it is possible to effectively prevent the positioning pin 9 from being stuck in the first hole 77 or the second hole 53. In addition, according to the above configuration, since it is possible to reduce the shear force due to the difference in thermal expansion amount between the first plate portion 71 and the second housing 5 acting on the positioning pin 9, it is possible to effectively prevent the positioning pin 9 from being stuck in the first hole 77 or the second hole 53.

As illustrated in FIG. 7, the second plate-like member 8 may include the second plate portion 81 described above, a shroud surface 84 formed on an inner peripheral end portion of the second plate portion 81, and a tubular portion 85 that protrudes forward from the inner peripheral end portion of the second plate portion 81 along the axial direction of the turbine wheel 3. The shroud surface 84 is curved in a convex shape so as to face a tip-side end (tip) of the plurality of turbine blades 32 and has a gap (clearance) between the tip-side end and the shroud surface 84. The first housing 4 may include the front side facing surface 45 facing the second back surface 83 of the second plate portion 81, and a step portion 47 that is continuous with the inner peripheral end of the front side facing surface 45 and that accommodates the tubular portion 85 of the second plate-like member 8.

As illustrated in FIG. 8, a tongue portion 48 of the scroll flow path 41 is formed between the start and the end of the winding of the scroll flow path 41. As illustrated in FIG. 8, in a cross section of the turbine wheel 3 orthogonal to the axial direction, a first reference line that is a straight line passing through the axis line LA of the turbine wheel 3 and the tongue portion 48 is defined as BL1, and a second reference line that is a straight line passing through the axis line LA of the turbine wheel 3 and orthogonal to the first reference line BL1 is defined as BL2. A side on which the tongue portion 48 is positioned with respect to the second reference line BL2 is defined as a tongue portion vicinity side S1, and a side separated from the tongue portion 48 with respect to the second reference line BL2 is defined as a tongue portion distant side S2.

In some embodiments, as illustrated in FIG. 9, the at least one positioning pin 9 described above includes a plurality of positioning pins 9 that are disposed at intervals along the circumferential direction of the turbine wheel 3. As illustrated in FIG. 9, in a cross section orthogonal to the axis line LA of the turbine wheel 3, a point CP at which the distances from respective center positions LD (for example, a centroid) of the plurality of positioning pins 9 are equal is disposed to be shifted to a tongue portion side of the scroll flow path 41 (tongue portion vicinity side S1) with respect to the axis line LA of the turbine wheel 3.

On the tongue portion vicinity side S1, which is a side closer to the tongue portion 48 of the scroll flow path 41 than to the axis line LA of the turbine wheel 3 of the variable nozzle unit 6, the temperature of gas flowing in the scroll flow path 41 is higher than that on the tongue portion distant side S2, which is a side opposite to and more distant from the tongue portion 48 than the axis line LA of the turbine wheel 3. Therefore, there is a concern that a difference in thermal expansion amount due to heat input from the gas flowing in the scroll flow path 41 between the tongue portion vicinity side S1 and the tongue portion distant side S2 is large, and a core deviation amount of the axis line LB of the variable nozzle unit 6 with respect to the axis line LA of the turbine wheel 3 is increased.

In the embodiments illustrated in FIGS. 4 and 7, in a case where the axis line LB of the variable nozzle unit 6 deviates from the axis line LA of the turbine wheel 3, there is a concern that an inner peripheral end portion of the first plate-like member 7 may come into contact with the second housing 5. In addition, in the embodiment illustrated in FIG. 7, there is a concern that an inner peripheral end portion of the second plate-like member 8 may come into contact with the turbine wheel 3.

According to the above configuration, by eccentrically disposing the point CP (center point between pins, centroid) at which the distances from the respective center positions LD of the plurality of positioning pins 9 are equal, to the tongue portion vicinity side S1 with respect to the axis line LA of the turbine wheel 3, the positioning pins 9 on the tongue portion vicinity side S1 can suppress the thermal expansion of the tongue portion vicinity side S1 as compared with a case in which the center point CP between the pins is either aligned with the axis line LA of the turbine wheel 3 or eccentrically disposed toward the tongue portion distant side S2. Therefore, the difference in thermal expansion amount between the tongue portion vicinity side S1 and the tongue portion distant side S2 can be reduced, and the increase in the core deviation amount of the axis line LB of the variable nozzle unit 6 with respect to the axis line LA of the turbine wheel 3 can be suppressed. In this case, it is possible to suppress the contact of the variable nozzle unit 6 with the first housing 4, the second housing 5, or the turbine wheel 3 due to the core deviation of the axis line LB of the variable nozzle unit 6 with respect to the axis line LA of the turbine wheel 3, and it is possible to suppress the excessive contact load acting on the positioning due to the contact. By suppressing the action of the excessive contact load on the positioning, it is possible to effectively prevent the positioning pins 9 from being stuck in the first hole 77 or the second hole 53.

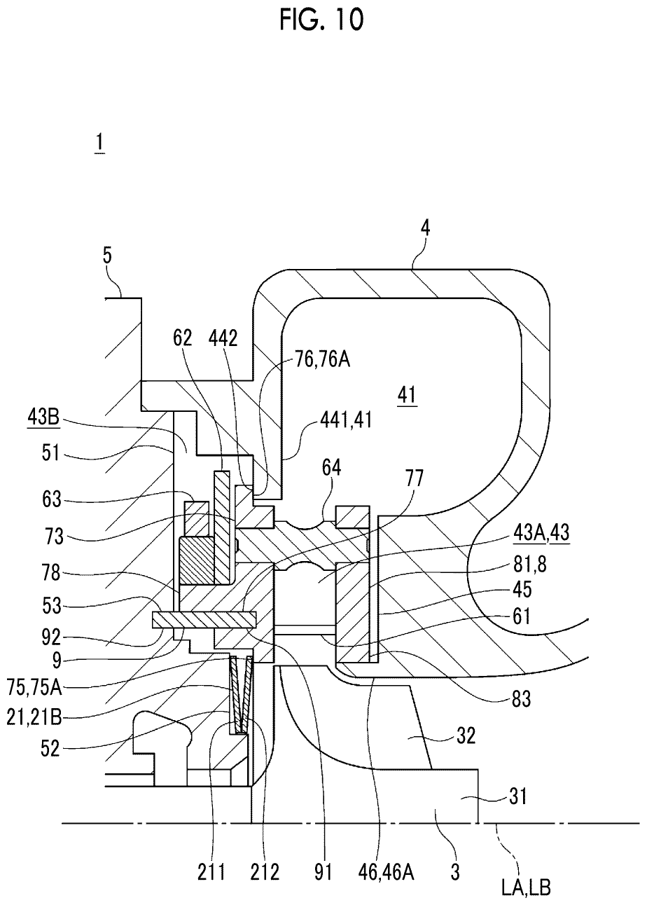

FIG. 10 is a schematic cross-sectional view illustrating a cross section taken along the axis line LA on one side with respect to the axis line LA of the turbine 2 according to one embodiment. In some embodiments, as illustrated in FIG. 10, the above-mentioned biasing member 21 (21B) includes at least a first biasing plate portion 211 that extends along a radial direction of the turbine wheel 3 and that abuts against the second housing 5, and a second biasing plate portion 212 that extends along the radial direction and that abuts against the first plate-like member 7.

In the illustrated embodiment, the first biasing plate portion 211 and the second biasing plate portion 212 are formed in an annular shape extending along the circumferential direction of the turbine wheel 3. An outer peripheral edge portion of the first biasing plate portion 211 abuts against the end surface 52 of the second housing 5, and an outer peripheral edge portion of the second biasing plate portion 212 abuts against the end surface 75A of the first plate portion 71. The biasing member 21 (21B) has an opening outward in the radial direction of the turbine wheel 3. In the embodiment illustrated in FIG. 10, the cross-sectional shape of the biasing member 21 (21B) is formed in a V shape.

According to the above configuration, the biasing member 21 (21B) including the first biasing plate portion 211 and the second biasing plate portion 212 can increase the pressing force (reaction force) on the first plate portion 71 as compared with a case where a single plate member such as a dish spring 21A abuts against the second housing 5 and the first plate-like member 7. By increasing the pressing force (reaction force) of the biasing member 21 (21B) on the first plate portion 71, the holding structure of the variable nozzle unit 6 (first plate-like member 7) can be maintained more stably.

As illustrated in FIG. 1, the turbocharger 1 according to some embodiments includes the above-described turbine 2 and the above-described centrifugal compressor 12. In this case, since the holding structure of the variable nozzle unit 6 (first plate-like member 7) can be stably maintained and the risk of abrasion or the like due to vibration of the variable nozzle unit 6 can be reduced, the reliability of the turbocharger 1 can be improved.

In the present specification, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, an expression such as “identical”, “equal”, or “homogeneous” representing a state where things are equal to each other does not strictly represent only the equal state, but also a tolerance or a state where there is a difference to the extent that the same function can be obtained.

In addition, in the present specification, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

In addition, in the present specification, expressions such as “comprising”, “including”, or “having” one component are not exclusive expressions excluding the presence of other components.

The present disclosure is not limited to the above-described embodiments, and includes a modification of the above-described embodiments and an appropriate combination of the embodiments.

Contents described in some of the above-described embodiments are understood as follows, for example.
1) A turbine (2) according to at least one embodiment of the present disclosure includes
a first housing (4) that has a scroll flow path (41);
a turbine wheel (3) that is provided on an inner peripheral side of the scroll flow path (41);
a first plate-like member (7) that includes an annular first plate portion (71);
a second plate-like member (8) that includes an annular second plate portion (81) that is disposed to face the first plate portion (71) and that forms a gas flow path (43A) from the scroll flow path (41) toward the turbine wheel (3) between the first plate portion (71) and the second plate portion (81);
at least one variable nozzle vane (61) that is disposed in the gas flow path (43A);
a second housing (5) that has a facing surface (51) that faces a back surface (73) of the first plate portion (71) on a side opposite to a flow path wall surface (72) facing the gas flow path (43A) with a first space (43B) interposed therebetween;
an annular member (62) that is disposed in the first space (43B) and that is configured to rotate with respect to the first plate-like member (7) by means of a driving force from an outside;
at least one link member (63) with one end being connected to the annular member (62) and the other end being connected to the variable nozzle vane (61), which changes a vane angle of the variable nozzle vane (61) connected to the other end in conjunction with the rotation of the annular member (62);
a biasing member (21) that is disposed between the second housing (5) and the first plate-like member (7) and that is configured to bias the first plate portion (71) toward a side of the gas flow path (43A);
at least one positioning pin (9) of which one end (91) is fitted into a first hole (77) formed in the back surface (73) of the first plate portion (71) and the other end (92) is fitted into a second hole (53) formed in the facing surface (51) of the second housing (5); and
at least one stopper portion (22) that is provided in the facing surface (51) or the first plate portion (71), in which a first gap (G1) is formed between the stopper portion (22) and the facing surface (51) or between the stopper portion (22) and the first plate portion (71), and the first gap (G1) is smaller than a second gap (G2) between the annular member (62) and the facing surface (51) and a third gap (G3) between the at least one link member (63) and the facing surface (51).

According to the configuration of the above 1), the first plate-like member (7) approaches a side of the second housing (5) due to thermal deformation during the operation of the turbine (2), but the movement of the first plate-like member (7) to the side of the second housing (5) can be restricted by bringing the stopper portion (22) into abutment with the facing surface (51) of the second housing (5) or the first plate portion (71). By restricting the movement of the first plate-like member (7) to the side of the second housing (5), it is possible to prevent the positioning pin (9) from being excessively inserted into the first hole (77) or the second hole (53) and being stuck in the first hole (77) or the second hole (53). By preventing the positioning pins (9) from being stuck in the first holes (77) or the second holes (53) and inhibiting the reaction force of the biasing member (21), the holding structure of the variable nozzle unit (6) (the first plate-like member (7)) can be stably maintained by the reaction force of the biasing member (21). By stably maintaining the holding structure of the variable nozzle unit (6), a risk of abrasion or the like due to vibration of the variable nozzle unit (6) can be reduced.
2) In some embodiments, in the turbine (2) according to the above 1), the at least one stopper portion (22) is integrally configured with the first plate-like member (7).

According to the configuration of the above 2), as compared with a case in which the stopper portion (22) is a member different from the first plate-like member (7) or the second housing (5), it is possible to suppress an increase in the number of components and to suppress an increase in the complexity of the structure of the turbine (2). In addition, in a case where the stopper portion (22) is integrally configured with the second housing (5), there is a concern that the stopper portion (22) interferes with the variable nozzle unit (6) when the variable nozzle unit (6) is mounted on the second housing (5). However, in a case where the stopper portion (22) is integrally configured with the first plate-like member (7), there is a relatively small concern that the stopper portion (22) interferes with the variable nozzle unit (6). In addition, forming the stopper portion (22) on the first plate-like member (7) is easier than forming the stopper portion (22) on the second housing (5).
3) In some embodiments, in the turbine (2) according to the above 1) or 2), the first plate-like member (7) includes a tubular portion (78) that protrudes from the back surface (73) of the first plate portion (71) and that is inserted into a central hole of the annular member (62), and at least one claw portion (22A) that protrudes from the tubular portion (78) to an outer peripheral side of an inner peripheral edge of the annular member (62), with the inner peripheral edge of the annular member (62) interposed between the back surface (73) of the first plate portion (71) and the claw portion (22A), and the at least one stopper portion (22) includes the at least one claw portion (22A).

According to the configuration of the above 3), by using at least one claw portion (22A) interposing the inner peripheral edge of the annular member (62) as the stopper portion (22), it is not necessary to newly provide a stopper portion (protrusion) on the first plate-like member (7). Therefore, it is possible to reduce the number of changes to the existing shape of the first plate-like member (7) and to reduce the complexity of the structure of the first plate-like member (7).
4) A turbine (2) according to at least one embodiment of the present disclosure includes
a first housing (4) that has a scroll flow path (41);
a turbine wheel (3) that is provided on an inner peripheral side of the scroll flow path (41);
a first plate-like member (7) that includes an annular first plate portion (71);
a second plate-like member (8) that includes an annular second plate portion (81) that is disposed to face the first plate portion (71) and that forms a gas flow path (43A) from the scroll flow path (41) toward the turbine wheel (3) between the first plate portion (71) and the second plate portion (81);
at least one variable nozzle vane (61) that is disposed in the gas flow path (43A);
a second housing (5) that has a facing surface (51) that faces a back surface (73) of the first plate portion (71) on a side opposite to a flow path wall surface (72) facing the gas flow path (43A) with a first space (43B) interposed therebetween;
a biasing member (21) that is disposed between the second housing (5) and the first plate-like member (7) and that is configured to bias the first plate portion (71) toward a side of the gas flow path (43A);
at least one positioning pin (9) of which one end (91) is inserted into a first hole (77) formed in the back surface (73) of the first plate portion (71) and the other end (92) is inserted into a second hole (53) formed in the facing surface (51) of the second housing (5), in a state of having a gap (93A, 93B) in at least one of the one end (91) or the other end (92); and an adhesive layer (94) that is interposed in the gap (93A, 93B) and of which an adhesive strength decreases due to heat input during operation of the turbine (2).

According to the configuration of the above 4), since the adhesive strength of the adhesive layer (94) is reduced due to the heat input during the operation of the turbine (2), a gap is generated between at least one of the first hole (77) or the second hole (53) and the positioning pin (9). Therefore, it is possible to prevent the positioning pin (9) from being stuck in the first hole (77) or the second hole (53) in a case where the first plate-like member (7) approaches the side of the second housing (5) due to the thermal deformation during the operation of the turbine (2). By preventing the positioning pins (9) from being stuck in the first holes (77) or the second holes (53) and inhibiting the reaction force of the biasing member (21), the holding structure of the variable nozzle unit (6) (the first plate-like member (7)) can be stably maintained by the reaction force of the biasing member (21). By stably maintaining the holding structure of the variable nozzle unit (6), a risk of abrasion or the like due to vibration of the variable nozzle unit (6) can be reduced.
5) In some embodiments, in the turbine (2) according to the above 4), the adhesive layer (94) is formed of a thermoplastic resin material.

According to the configuration of the above 5), the adhesive strength of the adhesive layer (94) is reduced by softening (for example, liquefying) the adhesive layer (94) formed of the thermoplastic resin material due to the heat input during the operation of the turbine (2), and thus the gaps (93A, 93B) can be effectively generated between at least one of the first hole (77) or the second hole (53) and the positioning pin (9).
6) A turbine (2) according to at least one embodiment of the present disclosure includes
a first housing (4) that has a scroll flow path (41);
a turbine wheel (3) that is provided on an inner peripheral side of the scroll flow path (41);
a first plate-like member (7) that includes an annular first plate portion (71);
a second plate-like member (8) that includes an annular second plate portion (81) that is disposed to face the first plate portion (71) and that forms a gas flow path (43A) from the scroll flow path (41) toward the turbine wheel (3) between the first plate portion (71) and the second plate portion (81);
at least one variable nozzle vane (61) that is disposed in the gas flow path (43A);
a second housing (5) that has a facing surface (51) that faces a back surface (73) of the first plate portion (71) on a side opposite to a flow path wall surface (72) facing the gas flow path (43A) with a first space (43B) interposed therebetween;
a biasing member (21) that is disposed between the second housing (5) and the first plate-like member (7) and that is configured to bias the first plate portion (71) toward a side of the gas flow path (43A);
at least one positioning pin (9) of which one end (91) is inserted into a first hole (77) formed in the back surface (73) of the first plate portion (71) and the other end (92) is inserted into a second hole (53) formed in the facing surface (51) of the second housing (5); and
a sliding layer (95) that includes a solid lubricant that covers at least one of an outer peripheral surface (911) of the one end (91) of the at least one positioning pin (9), an outer peripheral surface (921) of the other end (92) of the at least one positioning pin (9), an inner peripheral surface (771) of the first hole (77), or an inner peripheral surface (531) of the second hole (53).

According to the configuration of the above 6), since the sliding layer (95) reduces the frictional resistance between at least one of the first hole (77) or the second hole (53) and the positioning pin (9), it is possible to prevent the positioning pin (9) from being stuck in the first hole (77) or the second hole (53) in a case where the first plate-like member (7) approaches the side of the second housing (5) due to the thermal deformation during the operation of the turbine (2). By preventing the positioning pins (9) from being stuck in the first holes (77) or the second holes (53) and inhibiting the reaction force of the biasing member (21), the holding structure of the variable nozzle unit (6) (the first plate-like member (7)) can be stably maintained by the reaction force of the biasing member (21). By stably maintaining the holding structure of the variable nozzle unit (6), a risk of abrasion or the like due to vibration of the variable nozzle unit (6) can be reduced.
7) In some embodiments, in the turbine (2) according to any one of the above 1) to 6), at least one of the first hole (77) or the second hole (53) has a longitudinal direction along a radial direction of the turbine wheel (3).

The first plate portion (71) in which the first hole (77) is formed and the second housing (5) in which the second hole (53) is formed have a difference in thermal expansion amount during the operation of the turbine (2), and a shear force due to the difference in thermal expansion amount between the first plate portion (71) and the second housing (5) acts on the positioning pin (9). According to the configuration of the above 7), by setting a hole shape of the first hole (77) or the second hole (53) to have a longitudinal direction along the radial direction of the turbine wheel (3), the positioning pin (9) does not restrain thermal expansion between the first plate portion (71) and the second housing (5) as compared with a case where the first hole (77) or the second hole (53) is a round hole. Therefore, it is possible to suppress the occurrence of an excessive load between the positioning pin (9) and the first hole (77) or between the positioning pin (9) and the second hole (53), and thus it is possible to effectively prevent the positioning pin (9) from being stuck in the first hole (77) or the second hole (53). In addition, according to the configuration of the above 7), since it is possible to reduce the shear force due to the difference in thermal expansion amount between the first plate portion (71) and the second housing (5) acting on the positioning pin (9), it is possible to effectively prevent the positioning pin (9) from being stuck in the first hole (77) or the second hole (53).
8) In some embodiments, in the turbine (2) according to any one of the above 1) to 7), the at least one positioning pin (9) includes a plurality of positioning pins (9) disposed at intervals along a circumferential direction of the turbine wheel (3), and in a cross section orthogonal to an axis line (LA) of the turbine wheel (3), a point (CP) at which distances from respective center positions (LD) of the plurality of positioning pins (9) are equal is disposed to be shifted to a tongue portion side (S1) of the scroll flow path (41) with respect to the axis line (LA) of the turbine wheel (3).

On the tongue portion vicinity side (S1), which is a side closer to the tongue portion (48) of the scroll flow path (41) than to the axis line (LA) of the turbine wheel (3) of the variable nozzle unit (6), the temperature of gas flowing in the scroll flow path (41) is higher than that on the tongue portion distant side (S2), which is a side opposite to and more distant from the tongue portion (48) than the axis line (LA) of the turbine wheel (3). Therefore, there is a concern that a difference in thermal expansion amount due to heat input from the gas flowing in the scroll flow path (41) between the tongue portion vicinity side (S1) and the tongue portion distant side (S2) is large, and a core deviation amount of the axis line (LB) of the variable nozzle unit (6) with respect to the axis line (LA) of the turbine wheel (3) is increased.

According to the configuration of the above 8), by eccentrically disposing the point (CP, center point between pins, centroid) at which the distances from the respective center positions (LD) of the plurality of positioning pins (9) are equal, to the tongue portion vicinity side (S1) with respect to the axis line (LA) of the turbine wheel (3), the positioning pins (9) on the tongue portion vicinity side (S1) can suppress the thermal expansion of the tongue portion vicinity side (S1) as compared with a case in which the center point (CP) between the pins is either aligned with the axis line (LA) of the turbine wheel (3) or eccentrically disposed toward the tongue portion distant side (S2). Therefore, the difference in thermal expansion amount between the tongue portion vicinity side (S1) and the tongue portion distant side (S2) can be reduced, and the increase in the core deviation amount of the axis line (LB) of the variable nozzle unit (6) with respect to the axis line (LA) of the turbine wheel (3) can be suppressed. In this case, it is possible to suppress the contact of the variable nozzle unit (6) with the first housing (4,) the second housing (5), or the turbine wheel (3) due to the core deviation of the axis line (LB) of the variable nozzle unit (6) with respect to the axis line (LA) of the turbine wheel (3), and it is possible to suppress the excessive contact load acting on the positioning due to the contact. By suppressing the action of the excessive contact load on the positioning, it is possible to effectively prevent the positioning pins (9) from being stuck in the first holes (77) or the second holes (53).
9) In some embodiments, in the turbine (2) according to any one of the above 1) to 8), the biasing member (21(21B)) includes at least a first biasing plate portion (211) that extends along a radial direction of the turbine wheel (3) and that abuts against the second housing (5), and a second biasing plate portion (212) that extends along the radial direction and that abuts against the first plate-like member (7).

According to the configuration of the above 9), the biasing member (21 (21B)) including the first biasing plate portion (211) and the second biasing plate portion (212) can increase the pressing force (reaction force) on the first plate portion (71) as compared with a case where a single plate member such as a dish spring (21A) abuts against the second housing (5) and the first plate-like member (7). By increasing the pressing force (reaction force) of the biasing member (21 (21B)) on the first plate portion (71), the holding structure of the variable nozzle unit (6) (the first plate-like member (7)) can be maintained more stably.
10) A turbocharger (1) according to at least one embodiment of the present disclosure includes
the turbine (2) according to any one of the above 1) to 9); and
a centrifugal compressor (12) configured to be driven by the turbine (2).

According to the configuration of the above 10), since the holding structure of the variable nozzle unit (6) (the first plate-like member (7)) can be stably maintained and the risk of abrasion or the like due to vibration of the variable nozzle unit (6) can be reduced, the reliability of the turbocharger (1) can be improved.

### REFERENCE SIGNS LIST

1: Turbocharger
2: Turbine
3: Turbine wheel
4: First housing
5: Second housing
6: Variable nozzle unit
7: First plate-like member
8: Second plate-like member
9: Positioning pin
10: Internal combustion engine system
11: Internal combustion engine
12: Centrifugal compressor
13: Impeller
14: Compressor housing
15: Rotating shaft
16: Bearing
21: Biasing member
21A: Dish spring
22: Stopper portion
22A: Claw portion
31: Hub
32: Turbine blade
41: Scroll flow path
42: Exhaust gas discharge flow path
43: Internal space
43A: Gas flow path
43B: First space
44: Locked portion
45, 51: Facing surface
46: Shroud portion
46A, 84: Shroud surface
47: Step portion
48: Tongue portion
52, 75A: End surface
53: Second hole
54: Protrusion portion
61: Variable nozzle vane
62: Annular member
63: Link member
64: Support member
65: Driving mechanism unit
71: First plate portion
72: First flow path wall surface
73: Back surface
74: Through-hole
75: Inner peripheral edge portion
76: Outer peripheral edge portion
76A: Locking surface
77: First hole
78, 85: Tubular portion
81: Second plate portion
82: Second flow path wall surface
83: Second back surface
93A, 93B: Gap
94: Adhesive layer
95: Sliding layer
95A: First hole side sliding layer
95B: Second hole side sliding layer
BL1: First reference line
BL2: Second reference line
CP: Center point
G1: First gap
G2: Second gap
G3: Third gap
G4: Fourth gap
LA: Axis line
LD: Center position
P1: Rear end
S1: Tongue portion vicinity side
S2: Tongue portion distant side

1. A turbine comprising:
a first housing that has a scroll flow path;
a turbine wheel that is provided on an inner peripheral side of the scroll flow path;
a first plate-like member that includes an annular first plate portion;
a second plate-like member that includes an annular second plate portion that is disposed to face the first plate portion and that forms a gas flow path from the scroll flow path toward the turbine wheel between the first plate portion and the second plate portion;
at least one variable nozzle vane that is disposed in the gas flow path;
a second housing that has a facing surface that faces a back surface of the first plate portion on a side opposite to a flow path wall surface facing the gas flow path with a first space interposed therebetween;
an annular member that is disposed in the first space and that is configured to rotate with respect to the first plate-like member by means of a driving force from an outside;
at least one link member with one end being connected to the annular member and the other end being connected to the variable nozzle vane, which changes a vane angle of the variable nozzle vane connected to the other end in conjunction with the rotation of the annular member;
a biasing member that is disposed between the second housing and the first plate-like member and that is configured to bias the first plate portion toward a side of the gas flow path;
at least one positioning pin of which one end is fitted into a first hole formed in the back surface of the first plate portion and the other end is fitted into a second hole formed in the facing surface of the second housing; and
at least one stopper portion that is provided in the facing surface or the first plate portion, in which a first gap is formed between the stopper portion and the facing surface or between the stopper portion and the first plate portion, and the first gap is smaller than a second gap between the annular member and the facing surface and a third gap between the at least one link member and the facing surface.

2. The turbine according to claim 1,
wherein the at least one stopper portion is integrally configured with the first plate-like member.

3. The turbine according to claim 2,
wherein the first plate-like member includes
a tubular portion that protrudes from the back surface of the first plate portion and that is inserted into a central hole of the annular member, and
at least one claw portion that protrudes from the tubular portion to an outer peripheral side of an inner peripheral edge of the annular member, with the inner peripheral edge of the annular member interposed between the back surface of the first plate portion and the claw portion, and
the at least one stopper portion includes the at least one claw portion.

4. A turbine comprising:
a first housing that has a scroll flow path;
a turbine wheel that is provided on an inner peripheral side of the scroll flow path;
a first plate-like member that includes an annular first plate portion;
a second plate-like member that includes an annular second plate portion that is disposed to face the first plate portion and that forms a gas flow path from the scroll flow path toward the turbine wheel between the first plate portion and the second plate portion;
at least one variable nozzle vane that is disposed in the gas flow path;
a second housing that has a facing surface that faces a back surface of the first plate portion on a side opposite to a flow path wall surface facing the gas flow path with a first space interposed therebetween;
a biasing member that is disposed between the second housing and the first plate-like member and that is configured to bias the first plate portion toward a side of the gas flow path;
at least one positioning pin of which one end is inserted into a first hole formed in the back surface of the first plate portion and the other end is inserted into a second hole formed in the facing surface of the second housing, in a state of having a gap in at least one of the one end or the other end; and
an adhesive layer that is interposed in the gap and of which an adhesive strength decreases due to heat input during operation of the turbine.

5. The turbine according to claim 4,
wherein the adhesive layer is formed of a thermoplastic resin material.

6. A turbine comprising:
a first housing that has a scroll flow path;
a turbine wheel that is provided on an inner peripheral side of the scroll flow path;
a first plate-like member that includes an annular first plate portion;
a second plate-like member that includes an annular second plate portion that is disposed to face the first plate portion and that forms a gas flow path from the scroll flow path toward the turbine wheel between the first plate portion and the second plate portion;
at least one variable nozzle vane that is disposed in the gas flow path;
a second housing that has a facing surface that faces a back surface of the first plate portion on a side opposite to a flow path wall surface facing the gas flow path with a first space interposed therebetween;
a biasing member that is disposed between the second housing and the first plate-like member and that is configured to bias the first plate portion toward a side of the gas flow path;
at least one positioning pin of which one end is inserted into a first hole formed in the back surface of the first plate portion and the other end is inserted into a second hole formed in the facing surface of the second housing; and
a sliding layer that includes a solid lubricant that covers at least one of an outer peripheral surface of the one end of the at least one positioning pin, an outer peripheral surface of the other end of the at least one positioning pin, an inner peripheral surface of the first hole, or an inner peripheral surface of the second hole.

7. The turbine according to claim 1,
wherein at least one of the first hole or the second hole has a longitudinal direction along a radial direction of the turbine wheel.

8. The turbine according to claim 1,
wherein the at least one positioning pin includes a plurality of positioning pins disposed at intervals along a circumferential direction of the turbine wheel, and
in a cross-section orthogonal to an axis line of the turbine wheel, a point at which distances from respective center positions of the plurality of positioning pins are equal is disposed to be shifted to a tongue portion side of the scroll flow path with respect to the axis line of the turbine wheel.

9. The turbine according to claim 1,
wherein the biasing member includes at least
a first biasing plate portion that extends along a radial direction of the turbine wheel and that abuts against the second housing, and
a second biasing plate portion that extends along the radial direction and that abuts against the first plate-like member.

10. A turbocharger comprising:
the turbine according to claim 1; and
a centrifugal compressor configured to be driven by the turbine.
